(19) United States
(12) Patent Application Publication
(10) Pub. No.: US 2023/0217295 A1
(43) Pub. Date: Jul. 6, 2023

(54) WIRELESS SPECTRUM SHARING DATABASE

(71) Applicant: Worcester Polytechnic Institute, Worcester, MA (US)

(72) Inventor: Kaveh Pahlavan, Newton Center, MA (US)

(21) Appl. No.: 18/080,356

(22) Filed: Dec. 13, 2022

Related U.S. Application Data
(60) Provisional application No. 63/288,803, filed on Dec. 13, 2021.

(51) Int. Cl. H04W 28/02; H04W 28/08

(52) U.S. Cl. CPC H04W 28/0236; H04W 28/0983

(57) ABSTRACT

A spectrum management database and server provides measurement and modeling of RF (Radio Frequency) cloud interference in near real-time results for efficient utilization of the precious spectrum. This shared spectrum defines a scarce resource shared among all wireless devices of the universe in frequency, time, and space. Near real-time forecasting of the RF cloud interference is beneficial in pursuit of a path to the optimal utilization of spectrum and a liberated spectrum management. A spectrum management server gathers interference information including bandwidth ranges and locations from a plurality of deployed devices, receives requests for bandwidth, and satisfies the request by allocating a non-interfering bandwidth at a requesting location based on the stored indications

### RELATED APPLICATIONS

This patent application claims the benefit under 35 U.S.C. § 119(e) of U.S. Provisional Patent App. No. 63/288,803, filed Dec. 13, 2021, entitled “INTELLIGENT SERVER DATABASE FOR UPDATING INTERFERENCE CHARACTERISTICS FOR SPECTRUM SHARING,” incorporated herein by reference in entirety.

### BACKGROUND

Importance of spectrum regulation and management was first revealed on May of 1985 after the release of unlicensed ISM (Instrument Scientific and Medical) bands resulting in emergence of Wi-Fi, Bluetooth and many other wireless technologies that has affected our daily lives by enabling the emergence of the smart world and IoT (Internet of Things) era. Currently, the notion of a liberated spectrum is circulating around, which can potentially direct the wireless networking industry into another revolution by enabling a new paradigm in intelligent spectrum regulation and management. The RF signal radiated from IoT (Internet of Things) devices as well as other wireless technologies effectively creates an RFcloud tending to cause co- and cross-interference between the multitude of devices.

### SUMMARY

A spectrum management database and server provides measurement and modeling of the RF cloud interference in near real-time results for efficient utilization of the precious spectrum. This shared spectrum defines a scarce resource shared among all wireless devices of the universe in frequency, time, and space. Near real-time forecasting of the RF (Radio Frequency) cloud interference is beneficial in pursuit of a path to the optimal utilization of the shared spectrum through spectrum management. A spectrum management server gathers interference information including bandwidth ranges and locations from a plurality of deployed devices, receives requests for bandwidth, and satisfies the request by allocating a non-interfering bandwidth at a requesting location based on the stored indications.

Configurations herein are based, in part, on the observation that usage of wireless devices using cellular, WiFi®, Bluetooth® and various other services are continually expanding due to deployment of newer and faster personal wireless devices, entertainment and media usage, autonomous vehicles and wireless networking to replace former wired contexts. Unfortunately, conventional approaches to wireless telecommunications fail to provide an overall recognition that the underlying Radio Frequency (RF) spectrum is a shared resource burdened by all devices that invoke a transmission frequency. Entities purporting to manage and allocate bandwidth subranges across industries, such as the Federal Communications Commission (FCC), merely impose static ranges according to usage, without regard to management of time and bandwidth space within those mandated ranges. Accordingly, configurations herein substantially overcome the shortcomings of conventional wireless spectrum (RF) management by providing real-time or near real-time assessment and prediction of interference in a specific geographic region for allowing identification and deployment of useable and efficient bandwidth.

In further detail, a server, method and system for identifying interference in a shared spectrum environment of wireless devices includes a server and various data collection entities for gathering interference information including bandwidth ranges and locations from a plurality of deployed devices, and stores an indication of a plurality of locations and interference at each location based on the interference information. The stored and coalesced interference information identifies locations and interference at the respective locations for identifying bandwidths less likely to incur interference. The server receives a request for a bandwidth allocation emanating from a remote location, typically from a user device, and satisfies the request by allocating a non-interfering bandwidth at the remote location based on the stored indications.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a diagram of RF frequency usage;

FIGS. 2A and 2B depict an interference scenario in the bands of FIG. 1;

FIGS. 3A and 3B show time and frequency domain usage as in the scenario of FIGS. 2A and 2B;

FIG. 4 contrasts wireless and radar positioning;

FIG. 5 illustrates an interference scenario for N-interferes;

FIG. 6 shows wireless interference database server environment based on frequency usage as in FIGS. 1-5;

FIG. 7 shows a diagram of an interference map and corresponding interference metrics stored in the database; and

FIG. 8 shows a system for invoking the database in the environment of FIG. 6 for supporting telecommunications using a personal mobile device.

### DETAILED DESCRIPTION

The electromagnetic spectrum affects many aspects of daily life, yet as a mostly invisible medium, many do not appreciate or realize the substantial role it exhibits in common tasks and interactions. In particular, for telecommunications, governmental entities (the FCC in particular) regulate allocation of the electromagnetic spectrum to various entities and usage so that the many users and consumers of bandwidth do not interfere with each other from multiple attempts to use corresponding bandwidths, often appearing as interference when one broadcast or transmission attempts to use the same or similar bandwidth as another user in relatively close proximity.

For example, at present, GPS works in 99% of the vast available outdoor areas, while indoors, where most popular smart world applications and IoT devices exist, Wi-Fi and cell tower positioning support those indoor applications. In wireless networking, over a billion Wi-Fi access points, millions of 5G cellular base stations, and several billion smart phones carrying 5G cellular, Wi-Fi, and Bluetooth chipsets for communications, collectively enable formation of the IoT to communicate with close to hundred billion IoT devices and construct the so-called “smart world.” The RF signal radiating from these devices forms an RF cloud enabling emergence of numerous cyberspace applications for positioning, human-computer-interfacing, gesture and motion detection, and authentication and security. The RF cloud of each wireless device also contributes co- and cross-channel interference to other wireless devices in its area of coverage in and around its frequency of operation. Measurement and modelling of the interference contents of the RF cloud is important for intelligent spectrum management and regulation.

However, like spread spectrum technology, interference management has its own “Myths and Realities” caused by lack of a clear understanding of the meaning of the differences among intentional interference in military applications and unintentional interference in commerce as well as complexity of interference analysis in a constantly changing scenario of operation for billions of devices sharing the spectrum. The current spectrum management systems monitors the interference for spectrum management at fixed base stations for spectrum sharing in the C and L bands. With growth of the IoT and emergence of the smart world, what is needed is an Intelligent Interference Forecasting System (IIFS) to enable intelligent spectrum management at device level to lead us to a liberated spectrum access environment.

Approaches herein provide a holistic view of interference among different sectors of the industry and propose a path for the design of a centralized IIFS for near real-time spectrum monitoring and prediction. We begin with classification of major RF cloud contributors, and a historical overview of interference management and regulations. Then we provide an overview of the economic, political, and industrial meaning of interference for different sectors of the industry affected by interference management and how they can benefit from interference monitoring. Finally, we present a server, database, and framework to establish a foundation for scientific understanding of RF cloud interference and propose a practical approach for creation of an IIFS.

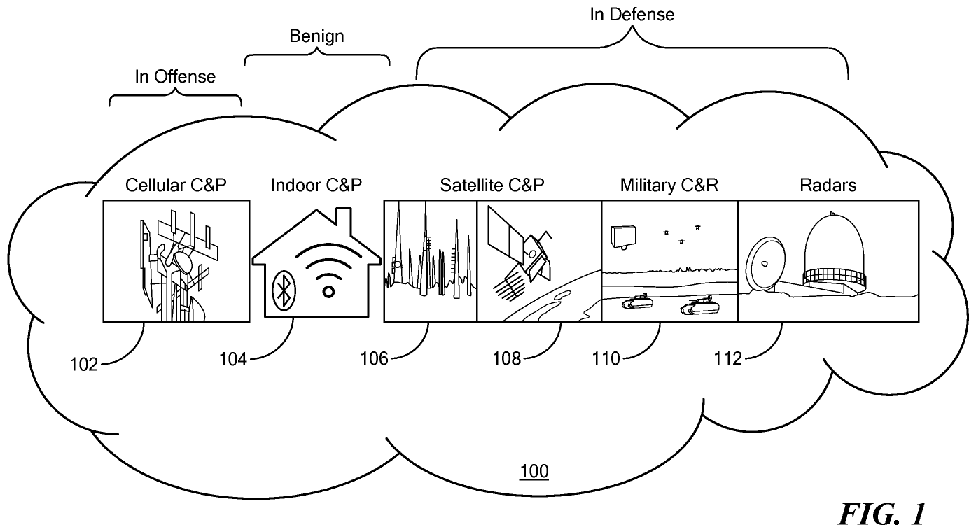

FIG. 1 is a diagram of RF frequency usage. The “RF cloud” 100 referred to herein is the radio wave propagated from RF devices in space in patterns guided by the devices' antennas, which range from close to ideal isotropic antennas propagating in all dimensions to massive multiple-input multiple output (MIMO) antenna systems with focused beam widths on the orders of a few degrees. Referring to FIG. 1, FIG. 1 shows the most common contributors to the RF cloud 100 for terrestrial and satellite wireless access and localization services in commercial and military applications. These contributors can be divided into wireless communications devices in urban 102 and indoor 104 areas (cellular wireless, Wi-Fi, Bluetooth), positioning systems (GPS 108, Wi-Fi, cellular), broadcasting services 106 (radio and TV), and radars 112 (astronomy, defense 110, navigation). All these contributors to the RF cloud 100 are sharing the same medium for RF propagation, the “air”, and cause co-channel and cross-channel interference to others in their area of coverage demanding government rules and regulations. Coverage of these devices varies from a few meters for RFIDs and short-range radars for motion monitoring up to astronomic distances for satellite communications and astronomy radars. Frequency spectrum is a unique natural resource shared among all these services by multiplexing in time, frequency, or space. In the U.S., the Federal Communications Commission (FCC), overseen by Congress, is responsible for implementation and enforcement of U.S. radio communications laws and regulations to manage the interference in location, frequency, and time. The most dominant quantitative measure for interference is the received Signal to Interference Ratio (SIR), also referred to as the Carrier to Noise ratio (C/I) and the FCC allocates bands according to different models of co- and adjacent-channel SIR levels.

The received signal to noise ratio (SNR) and the signal to noise plus interference ratio (SNIR) are defined as:

$$SNR = \frac{{P}_{r - D}}{{N}_{0} W} and SNIR = \frac{{P}_{r - D}}{{N}_{0} W + {P}_{r - l}} , \qquad ( 1 a )$$

where P_{r-D} is the received power from a desired source, P_{r-I} is the received power from an interfering device, No is the density of background thermal noise, and W is the bandwidth of the receiver. In this formulation SIR is given by:

$$SIR = \frac{{P}_{r - D}}{{P}_{r - l}}$$

The received power, Pᵣ, from a wireless transmitter follow the Friis equation, and it is modeled as:

$${P}_{r} = {{GP}_{t} ( \frac{λ}{4 π d} )}^{α}$$

where Pₜ is the transmitted power, λ, is the wavelength of the carrier frequency, G is the antenna gain (function of angular selectivity of the antennas), α is the distance-power gradient of the environment, and d is the distance between the transmitter and the receiver. Therefore, assuming normalized antenna gains, the relation between SIR and transmitted power from the desired and an interfering device is:

$$SIR = \frac{{P}_{r - D}}{{P}_{r - l}} = \frac{{P}_{t - D}}{{P}_{t - l}} {( \frac{D}{R} )}^{α} , \qquad ( 1 b )$$

where R and D, are distances between the desired and interfering sources from a target receiver, respectively. In practice, wireless access and localization devices are designed with a spectrum mask that ensures their proper performance inside the allocated spectrum and a controlled cross-channel interference with other wireless device operating in the neighboring bands. The co-channel interference becomes important during the geographical deployment of antennas for certain services to manage frequency-reuse and interference. In finding the geographical location for a broadcast radio or TV antenna tower, in planning for cellular deployment of a wireless network, or in installing a radar antenna in a site, calculation of SIR with this method is reasonable and practical. In these trends of deployments, the pattern of antenna deployment is predictable, making calculation of interference for or from a specific direction manageable. For a mobile wireless communication or a positioning system with a random location of the device, calculation of interference from multiple interferers becomes impossible demanding a method for empirical measurement and modeling of the interference (examples are disclosed below). However, all spectrum management and regulations rulings have been based on this basic simple model for interference.

From a historical perspective, spectrum management and regulation have evolved from licensing the spectrum to enable a few commercial broadcasting services operating in populated urban areas and to separate their spectrums from those licensed for the military applications in communications, positioning, and navigation. With the growth of the wireless commercial and military applications, the demand for spectrum increased and innovations in spectrum management and regulations began to emerge.

Established in 1934, the FCC manages the radio frequency spectrum in the United States for commercial and other non-federal uses, and since 1978 the National Telecommunications and Information Administration (NTIA) does the same for federal government use. In commercial applications, interference is unintentional and the FCC regulates the spectrum by studying the interference for efficient utilization of spectrum and to managing coexistence among multiple services to satisfy the growth of demand by consumers. The exponential growth of commercial wireless communications industry relies on availability of more spectrum and innovations by FCC in regulations. In design of military applications, the main concern is on intentional interference that does not have anything to do with frequency management and regulations. However, NTIA coordinates with the FCC to make sure that FCC's innovative regulations on spectrum management does not cause unintentional interference to military services operating in their licensed bands. In recent years interference from commercial wireless communications networks to the GPS has been a topic of long studies because GPS enables the defensive and offensive capability of guided terrestrial and aerial systems that are the cornerstone of modern warfare.

Frequency regulation for commercial wireless networks, began in mid-1980s when FCC licensed 25 MHz of bandwidth for uplink and downlink to the first generation (1G) Advanced Mobile Phone System (AMPS) cellular networks for operation in the United States. The bands were granted with a traditional mask based on the simple SIR models for co- and cross-channel interference. Each band was shared among two regional service providers each with 12.5 MHz of bandwidth for down- and up-link communications. The bandwidth was managed for multiuser deployment with each service provider originally with omni-direction antennas and eventually with three sectored antennas. The exponential growth of the wireless industry in 1990s demanded increase of capacity from wireless cellular service providers. The industry began discovering new technologies to increase the capacity and at the same time service providers began negotiating with the FCC for additional spectrum. The research community responded with the TDMA (Time Division Multiple Access followed by the CDMA (Carrier Division Multiple Access) technologies for the 2G and 3G cellular with a tenfold increase in capacity of cellular telephone and capability of supporting 2 Mbps data services. At that point, in mid-1990s, FCC began auctioning 20 MHz additional bands for approximately $20b for personal communication services (PCS). The high costs of the bands reflected the trade value of spectrum as a natural resource and how the government can auction that to promote more conscious usage of this scarce resource and to fuel competitive growth of the economy in the cellular wireless networking markets. In these auctions, the cellular wireless networking industry demonstrated its ability in generating capital for the growth of the economy. At the same time, auctioning of the new bands was allowing the cellular wireless providers to respond to the exponential growth of the subscribers to the cellular telephone services. However, emerging innovative wireless services such as the wireless local area networks needed much wider bandwidth, and they did not have economical resources to pay. This time FCC needed to come up with an innovative approach to interference regulation and management.

The importance of innovative regulation and management of spectrum was first experimented worldwide by FCC's innovative release of Instrument Scientific and Medical (ISM) unlicensed bands in May of 1985. The ISM bands are the first low-power unlicensed bands with restrictions on using spread spectrum technology to control and manage the interference at the devices. This first innovative step in spectrum management nurtured the emergence of bandwidth hungry Wi-Fi technology and the IEEE802.11 standards for wireless local area networking to become the dominant technology for the wireless Internet access and a gateway to the smart world. The unlicensed ISM bands became a public garden for experimental innovative wireless indoor technologies and, in addition to the use of Wi-Fi for local area networking, they nurtured other popular technologies such as Bluetooth® and ZigBee® for personal area networking. The new emerging expensive bands such as PCS bands became privately owned smaller back yards with permissions for much higher transmission power to cover metropolitan areas for expanding a mature industry such as cellular with an exponential growth in revenue. The trend of low power transmission for unlicensed operation continued by release of UWB spectrum at 3.1-10.6 GHz in early 2000s and mm-Wave at 57-64 GHz in 2010s nurturing cyberspace commercial applications for short-range wireless communications and radars.

The next step in innovative spectrum regulations for high-power licensed band wireless cellular networks happened around 2010 by auctioning white spaces in the broadcast TV bands for other wireless applications on a priority basis. From a technical point of view this regulation introduces a new method of interference regulation management demanding monitoring the channel to examine the availability of a licensed band for other applications at different time and locations and it resulted in emergence of cognitive radio science and technology and a path towards the tumultuous liberation in spectrum management. The trend continued into licensed priority access and spectrum monitoring for citizen band radio services (CBRS), and C-band auction, originally assigned for satellite communications, Wi-Max, and Navy, followed by the adoption of L-bands in the vicinity of GPS bands, originally assigned for satellite communications. Currently, CBRS-bands are used for terrestrial wireless cellular networking application in a priority base, C-band auction is completed, and L-band is under evaluation for terrestrial use. In these priority spectrum management techniques, spectrum regulation mandates near real-time interference monitoring before transmission at the base station. In licensed bands, ownership of the band is by a single service provider and interference monitoring is only applied by the service provider for deployment of the infrastructure in their own bands. In unlicensed bands, interference monitoring is not mandated, but the medium access controls evolved for unlicensed bands (for example in IEEE 802.11 or 802.15.4) have adopted carries sense multiple access (CSMA) protocols, in which a devices senses (monitors) the channel before transmission as a liberal method for interference management and co-existence.

The white space in the TV bands, CBRS, C-bands, and L-bands are under a few GHz and penetrate the walls making them a better suite for populated urban canyons and indoor operations, where most modern cyberspace applications occur. In parallel to discovery of these bands, the wireless communications networking industry is also discovering higher frequencies, where wider spectrum bandwidths are available. The mmWave bands are adopted for 5G, and researchers are discovering THz and optical quantum communications for the future of wireless cellular networks. In these higher frequencies wireless networks should share the spectrum with astronomy radars and the understanding of the interference and methods for sharing the spectrum is under investigation. Empirical interference monitoring and near real-time interference modeling is an essential component for efficient spectrum management and regulation and the future of the wireless cellular networks to enable sharing the spectrum at lower frequencies for larger cell and at higher frequencies for smaller cells.

Although the FCC regulates level of acceptable co- and cross-channel interference with a similar interpretation of interference, the impact of interference on the performance of different sectors of the wireless communications and positioning industries are quite different. Performance of the communication systems is measured by maximum achievable data rate, or capacity, C, that is related to the bandwidth, W, the signal to noise ratio, SNR, and the selectivity of the antenna system expressed by the generalized Shannon-Hartley bound for MIMO systems:

$$C \leq W {\sum }_{i = 1}^{N} {log}_{2} ( 1 + \frac{SNIR}{N} {λ}_{i} ) , \qquad ( 2 a )$$

where λᵢs are the eigenvalues of the N×N cross correlation matrix of the channel gains between the elements of the transmitter and the receiver antennas. For N=1 and the uncorrelated channels λᵢ=1, this equation is reduced to the classical form of the Shannon-Hartley bound:

C≤log₂(1+SNIR) (2b)

Performance of the positioning systems (GPS or Radar) are measured by ranging precision of the systems and the minimum variance of distance measurement error given by the Cramer-Rao lower bound (CRLB). The CRLB for a MIMO antenna system with an N×N transmitter antenna system is:

$$C R L B = \frac{48 {σ}_{r}^{2}}{N ( {N}^{2} - 1 ) {cos}^{2} α} , r \qquad ( 3 a )$$

where α is the angle of arrival of the signal, and a² is the variance of the distance measurement error for omnidirectional antennas, given by:

$${σ}_{r}^{2} \geq \frac{{c}^{2}}{8 {π}^{2} \times SNIR \times W \times {T}_{M} ( {f}_{0}^{2} + {W}^{2} / 12 )} , \qquad ( 3 b )$$

in which T_{M} is the measurement time for calculation of the location.

As intuitively expected, both wireless communications and positioning system performances are improved with the increase in the bandwidth and a decrease in the level of the interference. However, performance measurement criterion and details of derivations are quite different resulting in a diversified and complex relation toward spectrum management and regulations. We divide wireless industries into the wide and local area wireless communications and the positioning and radar systems to study their views of the spectrum management and regulations and analysis of the effects of interference. That complexity and diversity has created challenges in timely decision making for spectrum management by FCC and other agencies involved in regulation, causing delays in the economic growth of vital industries in the competitive wireless communications industry. We proceed with an overview by examples to give a broad understanding of the vital issues in spectrum regulation and management in different sectors of the industry.

Among all wireless communications industries, cellular wireless grew for wide area operation in licensed bands with mainly outdoor antenna deployments. For this industry “spectrum is not only the lifeblood but also influences 5G supply chain integrity, economic growth, and national security”. Cellular wireless services support comprehensive coverage, high mobility for operation in the vehicles, controlled delays for the time sensitive applications, and they face an exponential growth of demand for more bandwidth. The cellular wireless service providers own a portfolio of licensed bands and deploy their base stations based on frequency reuse and a centralized co-channel interference control and management. The deployment of cellular infrastructure is based on a cell hierarchy with different cell sizes. Smaller cells operate with lower power and support higher capacity per unit of bandwidth with lower mobility. Larger cells operate at higher power and support lower capacity per unit of bandwidth with higher mobility. The interference generated by small cells is more uniformly distributed over the area of coverage. The traditional cell hierarchy includes macro-cells with a coverage of a few Km with a typical transmitted power of 40 W, micro-cells with 500 m coverage and 5 W transmitted power, pico-cells with 200 m coverage and 2 W power, and femto-cells with 30 m coverage and 100 mW power. All cellular base station antennas are deployed outdoors, except for some femto-cell antennas that are deployed indoors. In indoors, femto-cells compete with Wi-Fi, which carries 70% of the total IP traffic without a need for subscription to a cellular service provider. These very small cells transmit at low power of approximately 100 mW and they are barriered by an additional 10-20 loss to penetrate to outdoors containing their interference inside the building. As a result, the impacts of interference from other cells with outdoor antenna deployments are more and as the size of cell and consequently transmitted power level increases, they raise more concerns on cross-channel interference with other licensed spectrums in their neighboring bands. With the recent trends in releasing satellite bands for terrestrial applications that we discussed in Sect. 2.2, there is a need for understanding the impact of interference from the cellular wireless networks operating in the L bands neighboring to the GPS bands.

Wireless cellular service providers are not concerned with out of band interference from others operating in their neighboring bands, they are concerned with co-channel interference control for frequency reuse and efficient spectrum management for deployment of the cellular infrastructure. Cellular networks are interference limited networks, and their capacity increases with reduction of the interference. However, this interference is co- and cross channel interference in the bands that they own. Traditionally, service providers calculate SIR for the frequency reuse factor (N_{f}):

$$SIR = \frac{1}{{J}_{s}} {( 3 \sqrt{{N}_{f}} )}^{α}$$

where α is the distance power-gradient of the environment,¹ Jₛ is the number of interfering neighboring cells that is a function of the spatial selectivity of the antennas. For omni-directional antennas Js=6 and for the three sector antennas, Js=2. In the 4G and 5G cellular and beyond macro-cells are deployed by frequency reuse factor of three and smaller cells with frequency re-use factor of one in an overlay-underlay setting where the interference among smaller cells is controlled by physical separations beyond their coverage areas. The huge MIMO antenna systems with very narrow beamforming capabilities theoretically can eliminate the interference allowing availability of the entire spectrum for each individual end user. As a result, in 5G they migrated to massive MIMO and for 6G they study super-massive MIMO antenna systems for their capabilities in producing narrower beams and to support higher number of streams.

Today, cellular service providers own a portfolio of bands at different frequencies with different power and priority restrictions. To expand this portfolio the cellular wireless industry has also resorted to higher frequencies, the 5G industry discovered the mmWave and THz technologies are emerging for 6G and beyond. These bands share the spectrum with radars for the military and commercial applications in a variety of bands for environmental monitoring and astronomy and that has initiated research studies in the interference caused by cellular industry into these industries. Since in these frequencies RF signal does not penetrate the walls, the wireless industry also have resorted to spectrum sharing with other license spectrum holders at lower frequencies for applications demanding through the wall penetrations. Spectrum sharing demanded interference monitoring and cognitive radios, and it began with the white bands for broadcasting services, followed by C-band for satellite communications, and L bands with potential interference with neighboring GPS bands. This situation initiated a momentum for research in the interference monitoring science and engineering to enable a new foundation for decision making and intelligent spectrum management. What is important for the cellular wireless industry is more efficient use of the spectrum in time, frequency, and space in metropolitan areas with high density of population. To increase the efficiency, we need to monitor the interference in the available spectrum to enable spectrum sharing. Analysis and understanding of the nature of interference and near real-time interference assessment for intelligent spectrum management is an important area for research and developments for the US cellular wireless industry to maintain its competitiveness and security.

The ISM bands released in May 1985 were the first unlicensed bands with low-power transmission (less than one-Watt) that also enforced spread spectrum transmission with a minimum processing gain of ten to further control the interference to other devices. The IEEE 802.11 Wi-Fi for local networks followed by IEEE 802.15 Bluetooth for personal area networking were the leading popular commercial standards emerging in these bands with the spread spectrum technology in late 1990s. The maximum transmission power of Wi-Fi and eventually Bluetooth are 100 mW and both are mainly deployed indoors where exterior walls provide a 10-20 dB shield that further contain the interference to indoors. The background of spread spectrum radio designers that were engaged in that emerging industry was in design of spread spectrum systems for military applications to counteract the effects of intentional interference from a variety of jammers. Unlicensed bands were released to nurture commercial application developments where interference is unintentional. However, designers of early spread spectrum devices in ISM bands were coming to the field with past military design applications and they were paranoid from the effects of interference rooted in the history of design of spread spectrum communications systems for military applications. A review of some of these experiences as examples may help future spectrum regulations when military and commerce come with different interpretation of interference in disputable bands such as L bands.

In the first few years of the IEEE 802.11 standardization process, they were deciding on 2.4 GHz bands as a better option over 900 MHz, because 2.4 GHz was available worldwide and it had wider bandwidth (84 MHz at 2.4 GHz vs 26 MHz at 900 MHz) allowing more alternative channels for communications. One of the issues working against adoption of 2.4 GHz that was discussed in length in the early IEEE 802.11 committee meetings was interference from microwave ovens. Researchers at Hughes Network Systems, San Diego, a military communication company keen on discovering commercial applications for military communication technologies, had a thorough study of characteristics of interference from microwave ovens to present to the IEEE 802.11 community [22, 23]. The IEEE 802.11 finally decided on 2.4 GHz, neglecting the significance of interference from the microwave ovens reported to the committee. Today, many of us use Wi-Fi in our kitchens and next to our microwave ovens and some microwave ovens are remotely controlled by Wi-Fi. This example reflects that unlike intentional interference in military communications that we design our systems to manage them, in commercial unintentional interference operation in the liberated unlicensed bands interference exists but we live with it without any special effort.

The second time that interference in unlicensed bands attracted attention was at the emergence of the IEEE 802.15.1 Bluetooth technology in late 1990s, right after finalization of the IEEE 802.11 and emergence of the IEEE 802.11b as the first successful Wi-Fi technology capturing the sizable small business and home office (SOHO) market for wireless Internet access. At that time many progressive large corporates, such as Fidelity® Headquarters in Boston, had invested in deployment of IEEE 802.11b infrastructure to enable their task force to carry their laptops within the corporate buildings as well as to their home. The executives behind these decision makings and financial investments became panicked of the effects of interference from Bluetooth to jeopardize the company's investments. Again, at that time, most technical people behind the decisions had military communication background and were paranoid of interference and its impact on security of the network. This time the scenario for paranoia was strong enough and more realistic that it initiated the IEEE 802.15.2 to address the interference and discover methods for co-existence between Wi-Fi and Bluetooth in 2.4 GHz ISM bands. Although the transmission power of the IEEE 802.11b was 20 dBm (100 W) and the Bluetooth in US operated with 0 dBm (1 mW) to control that interference, understanding of this new interference scenario in unlicensed bands and discovery of a standard guideline to help co-existence in unlicensed bands became the charter of the IEEE 802.15.2.

The interference scenario and method for the analysis of interference for the IEEE 802.15.2 was fundamentally different from the scenario for interference analysis in cellular networks. In cellular networks a service provider deploys the infrastructure in a licensed band following a specific frequency reuse pattern that is related to the transmission technology, the service provider manages the interference among devices centrally, and all devices use the same transmission technology. In the IEEE 802.15.2 interference scenario, deployment is random and often by different entities without much of coordination for interference management, and transmission technologies for different devices are different. The IEEE 802.15.2 began its study by defining an application scenario for this complex and diversified interference analysis problem involved in SIR as well as details of different transmission techniques recommended by the IEEE 802.11 Wi-Fi and the IEEE 802.15.1 Bluetooth.

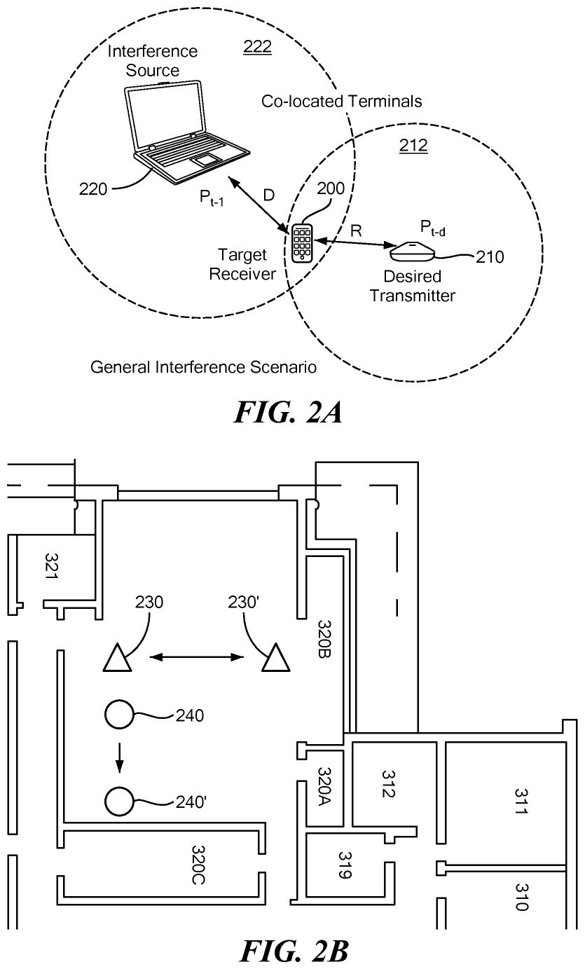

FIGS. 2A and 2B depict an interference scenario in the bands of FIG. 1. Referring to FIGS. 1 and 2A, FIG. 2A shows the basic concept of the interference scenario defined by the IEEE 802.15.2, for this scenario we can calculate the SIR from Eq. (1b) using transmitted power and distances 212, 222 of desired device 200, P_{D}, R, desired transmitter 210, and interfering device 220, P_{I}, D. FIG. 2b, shows a typical implementation of this scenario in the CWINS laboratory at the third floor of the Atwater Kent Laboratories, Worcester Polytechnic Institute, Worcester, Mass. With this scenario we can determine how close two devices 230, 230′ and 240, 240′ should get to interfere with one another. However, to measure the impact on the user experience, the IEEE 802.15.2 began analysis of the effects of interference of each device in increasing the packet error rate of the others. This analysis goes beyond the coverage calculation of each device and gets engaged with the details of signals transmitted from the devices in the time and in the frequency.

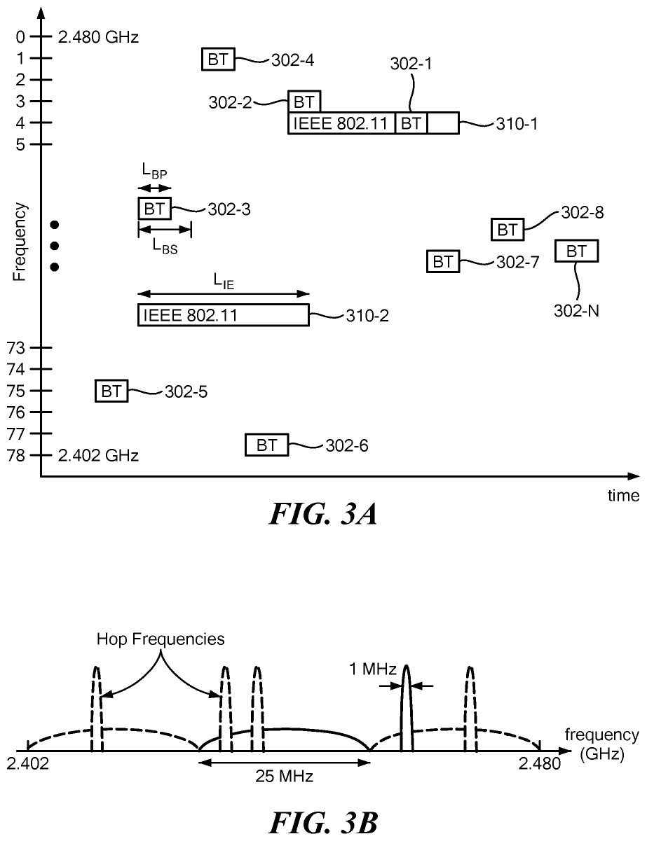

FIGS. 3A and 3B show time and frequency domain usage 300 as in the scenario of FIGS. 2A and 2B. Referring to FIGS. 3A and 3B, FIG. 3A shows a typical time-domain interference scenario between long packets 310-1, 310-2 (310 generally) of the FHSS IEEE 802.11 and Bluetooth's shorter packets 302-1 . . . 302-N (302 generally). BT packet 302-1 interferes (overlaps) with packet 310-1, which is in an adjacent GHz band to BT packet 302-2. FIG. 3B shows the interference scenario between IEEE 802.11b (or DSSS 802.11) with 26 MHz bandwidth and 1 MHz Bluetooth bands with random hops. These examples reveal the complexity of the interference analysis in the time- and in the frequency-domain. Considering differences in the medium access methods adopted by different technologies add to this complexity demanding more in depth analysis and empirical measurement studies to understand the real impact of interference in unlicensed bands.

One of the early studies in this area to analyze the interference among IEEE 802.11b and Bluetooth (FIG. 3B) has been reported. This study uses the IEEE 802.15.2 scenario in FIG. 2B to analyze the effects of mutual interference among the two wireless communications technologies and demonstrates that calculation of interference with antenna power from Eq. (2b) is far more pessimistic than that of empirical measurement of packet error rate (PER) like those in FIGS. 3A and 3B. From these observations, we can conclude that analysis of interference in liberated unlicensed bands is a complicated problem and the correct approach for a realistic solution involves empirical measurement of PER while SIR provides a bound on how close the two devices should be to interfere with each other. The difference of calculation of interference base on SIR and the PER becomes more complex as we include the effects of MIMO antenna systems with beam forming capabilities. In these cases, the angular orientation of antennas also plays a role in the interference. An example case study for the analysis of interference among wireless technologies using MIMO antenna systems has been performed. This study analyzes the mutual interference among IEEE 802.11ad wireless communication devices and the short range mmWave radars both benefitting from MIMO antenna systems and operating in unlicensed mmWave 60 GHz bands. As we explained earlier, wireless communication performance is reflected by Shannon-Bounds (Eq. 2a), while performance of positioning systems is measured by CRLB (Eq. 3) posing another challenge for analysis of the effects of interference on the user applications of wireless devices. One study reveals that while the interference from mmWave radars to IEEE 802.11 communications devices affects the PER of the communication device, the interference from the IEEE 802.11 communications devices only reduces the range of coverage of the mmWave radar without any significant effect on its precision.

The IEEE 802.15.2 standard arrived at recommendations for coexistence in 2003 and later these recommendations were withdrawn [27]. However, studies of this committee revealed the fact that the simple SIR analysis cannot lead to a realistic understanding of the effects of interference in non-homogeneous wireless communications devices operating in liberated unlicensed bands. They addressed the complexity of this problem and they proposed a methodology for empirical modeling of the interference, and among all they also recommended listen before talking (LBT) as a protocol for operation in these environments. The LBT was implemented in CSMA based protocols of the IEEE 802.11 before and in the IEEE 802.15.4 (ZigBee) later. These studies also pointed to the need for a new theoretical foundation for interference analysis to enable intelligent spectrum management.

Another notable misunderstanding on the nature of interference affecting FCC regulation on unlicensed bands occurred in early 2000s, when UWB technology emerged for low power transmission and precise ranging. In 2002 FCC released the UWB unlicensed bands at 3.1-10.6 GHz to enable this technology studied by the IEEE 802.15.3a [9]. The lead UWB company, the Time Domain Corporation, Huntsville, Ala., had implemented their technology with baseband pulses with super low power density across all other licensed and unlicensed applications in the first 5 GHz of spectrum. The GPS community came with a strong statement against the role making arguing that GPS operates in very low power and UWB can potentially damage its performance. As a result, FCC changed its spectrum profile and included a notch in the GPS and its neighboring bands. Today, UWB products emerged in these bands are mainly used for precise indoor positioning and the GPS does not work indoors with or without interference from UWB devices. May be FCC could allow t e UWB operation in full band only for indoor applications.

The examples above demonstrate that interference has been tracked and quantifiable assessed for wireless communications in licensed and unlicensed bands to explain the nature and complexity of understanding the real impact of interference in different wireless communications systems designed for military and commercial applications. We also provided a few examples of the impact of misunderstanding of the difference between intentional interference in military applications and unintentional interference in commercial applications causing delays in commercial developments. In this section and the next we review the effects of interference in the two classes of localization technologies: the active positioning systems, and passive radars.

Performance criteria for localization systems is the precision of positioning reflected by the variance of the distance measurement error calculated from the CRLB given by Eq. 2a. The CRLB is a function of bandwidth, SNR, and the measurement time that means if we change the SNR two times (3 dB) precision or standard deviation of error will increase 1.43 times. Equation 2 also reflects that we can compensate for that 3 dB loss of signal power by doubling the measurement time. That means if we have a location fix in one second and we increase it to two seconds, we compensate for a 3 dB loss of power. Another alternative to compensate for the precision is to double the bandwidth and we already know how expensive it is. Waiting for the location fix is very important in automated tracking systems such as autonomous driving vehicles and automated weaponry systems. In most other military and commercial positioning and navigation applications we can often compromise on the less expensive waiting time.

The first popular positioning system for military, public safety, and commerce, the GPS, covers approximately 99% of the vast outdoor areas on the globe but not indoors, where approximately 80% of the IP traffic is generated to enable smart world applications. In open outdoor areas, the GPS can achieve precision of approximately 1m for military applications, but in multipath urban areas, where all the smart world popular applications take place, GPS has a precision of 10-15 m. The significant performance degradation of GPS in these environments is due to the extensive multipath conditions. The other two popular positioning systems, Wi-Fi positioning systems (WPS) and cell-tower positioning systems (CPS), emerged for coverage in indoors and outdoors. The WPS is the most popular in smart world applications and it has a precision of 1-15 m depending on availability of indoor fingerprints in the databases of the system. The WPS works in major populated indoor and urban areas, but not in highways and vast open areas. The CPS extends the coverage of the WPS to highways and open areas but the precision of its existing technologies are substantially lower. With the popularity of MIMO antennas and with narrow beam forms in 5G and beyond, precision of the CPS systems are expected to improve significantly.

In the world of commerce, the three positioning technologies, GPS, WPS, and CPS, complements each other based on availability of these technologies in the platform of operation. Today, several billions of smartphones worldwide carry all three positioning technologies, computing equipment (tablets, laptops, PCs), as well as smart devices (TVs, security systems, and IoT devices) do not have cellular or GPS chipsets and by default they benefit only from WPS. The largest commercial market for the GPS grew after its integration in the second generation iPhone. The first generation of iPhone was only relying on WPS and CPS [28]. Each smartphone enables millions of software applications and most of these applications benefit from a sort of positioning for a variety of applications covering classic turn-by-turn navigation, as well as searching for services from Google® or Yelp. Majority of these applications benefit from Wi-Fi positioning data bases and for that reason the databases, such as the original Skyhook database, receive over a billion hits per day. However, still turn-by-turn navigation remains as the most popular positioning application in smartphones and outdoor turn-by-turn navigation relies on GPS as the first option.

The GPS operates in its own licensed L bands and the US Government funded the expensive GPS satellite infrastructure because of its importance for military applications. The WPS and CPS are opportunistic positioning systems benefitting from the existing infrastructure of Wi-Fi access points operating in unlicensed bands and cell-towers infrastructure for wireless communications operating in privately owned licensed bands. The GPS is the heart of navigation of aerial and terrestrial vehicles for commercial and military applications and it is used for many commercial applications in wide open areas. Military and public safety applications give a special weight to GPS technology and maintenance of its precision for guided missiles and drones. Mitigation of intentional interference to the GPS has been an area of research for military applications for many years. Recently, effects of unintentional interference from neighboring wireless communications systems operating in L bands has been under investigations. The WPS and the CPS technologies emerged for commercial applications and they adjust and live with the interference.

GPS is tied with precision tracking for national security and military applications to direct missiles and drones to targets and it has found its way in a variety of commercial applications in avionic and space, robotics and machine control, agriculture, scientific, timing, and survey and mapping. Analysis of interference in GPS has turned to a complicated problem with technical complexities, economic considerations, and political concerns. To help this situation, it is beneficial to monitor the interference in GPS bands in indoor and urban areas as a scientific endeavor for potential research on impact of interference and comparative evaluation of the effects of multipath on intentional and unintentional interference in GPS for hostile applications in urban areas. The frequency administration agencies can benefit from the better understanding of the effects of interference to come up with new methods for intelligent interference regulation and management to avoid un-necessary role making. As we explained in Sect. 3.2, the IEEE 802.11 and the IEEE 802.15 had experiences in this domain that should not be neglected. Having a theoretical foundation for analysis of interference can resolve many of these discrepancies and uncalled for paranoic interpretations of interference. The GPS manufacturers can also tighten the sharpness of their front end receivers to better controls the cross-channel interference from neighboring bands.

Radar was invented for military applications during World War II and currently they operate in a variety of traditional licensed spectrums applications for locating distance objects in astronomy, navigation, imaging, and environmental monitoring. More recently, short range mm-Wave and UWB radars operating in unlicensed bands becoming popular for emerging cyberspace applications in human-computer interaction, gesture and motion detection, and authentication and security. Like any other wireless access and localization systems, radar has a transmitter and a receiver, but transmitter and receiver are in the same location. Therefore, radars are also subject to the cross- and co-channel interference.

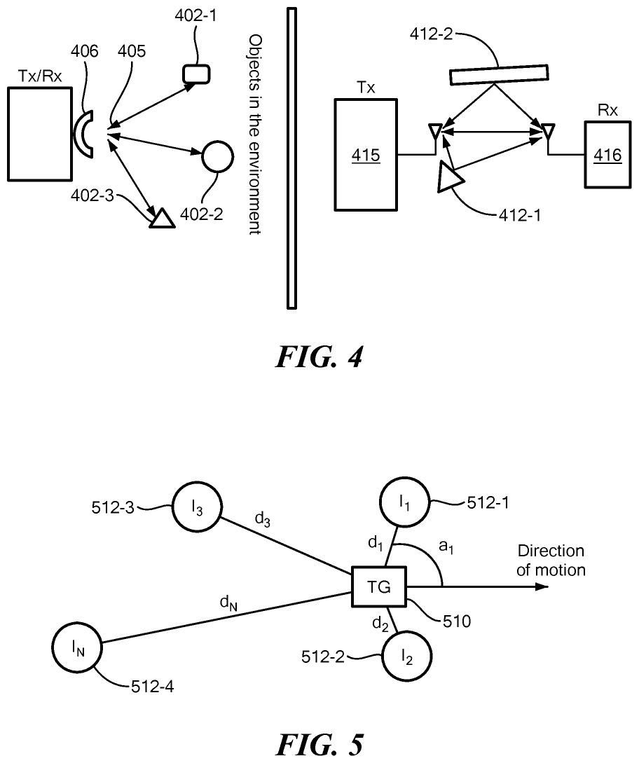

FIG. 4 contrasts wireless and radar positioning; Like positioning systems, the objective of a radar is to position location of targets 402-1 . . . 402-2 As shown in FIG. 4, the difference between wireless positioning systems and radar is that in with radar, the target does not participate in positioning, making radar a passive positioning system. The radar transmitter 405 and receiver 406 are co-located, while in transport approaches the transmitter 415 and receiver 416 are distal, and transmissions reflect from objects 412-1 . . . 412-2 to both the transmitter and receiver.

Like positioning systems, performance of a radar is measured with the CRLB and precision of positioning (Eq. 2a) and it is affected by interference, bandwidth, frequency of operation, and the measurement time. Radars are more sensitive to interference than positioning systems because the received signal is reflected from the target making it a much weaker signal. Most popular radars operate with MIMO antenna systems with beamforming to position the targets with the range and the angle of arrival of the signal reflecting from the objects. As we discussed before, directional antennas create an embedded mechanism to reduce the interference from other devices as well as interference they cause in other devices. Radars sweep the space in different angles periodically with a gap time between sweeps to save in transmitted power. This feature makes radars look like an impulse interference source to other wireless devices.

Long range radars operating in licensed bands are popular in passive navigation and tracking of aeronautical and terrestrial object in military and commercial systems. A unique application of radars is in astronomy, in which the objects are far away, the received signals are very weak, and interference sources are much closer than the targets. At the same time, many of these radar systems do not fully utilize their licensed bands in time and in the terrestrial locations. In the commercial world the bandwidth hungry wireless communication networks are eager to share these bands with them but that demands a realistic understanding of interference. A near real-time interference forecasting system helps resolving this situation and opens a horizon for discovery of more innovative and realistic algorithms for intelligent spectrum management for these applications.

A theoretical analysis of interference between wireless communications devices and radars have been a challenging problem. Thanks to the growth of wireless networking industry, recently low cost miniature UWB and mmWave radars in unlicensed bands have emerged in the market. We have miniature short range radars at 3-10 and 60-70 GHz that operate in unlicensed bands that are available for scientific study of the effects of interference between wireless communications devices and the radars to lay a theoretical foundation for understanding the nature of interference among communication and positioning systems. Previous paragraphs provided an example study in this area for the analysis interference between IEEE 802.11ad and the mmWave radars operating at 60 GHz. Using these devices, we can also study the UWB radars and IEEE 802.11ac/ax operating in 3-10 GHz spectrums and many other scenarios to lay a theoretical foundation for RF cloud interference analysis.

Better understanding of characteristics of the RF cloud interference is necessary to enable the emerging new paradigms for intelligent and liberated spectrum management and regulations. This challenge demands a theoretical foundation for a near real-time RF cloud interference monitoring and forecasting. The interference analysis and design of counter-interference measures for RF military communications, positioning, and navigation applications has been a subject of decades of research. The research objective for these applications were the design of robust communications, positioning, and navigation systems to counter the effects of un-controllable intentional short-time interference. The nature of interference in military applications is intentional, interference sources are often limited in numbers, and the period of interference is limited to the duration of military conflicts or disaster recoveries. In the commercial world interference is unintentional, we have unlimited interfering devices, and the duration of interference has no limits in time.

As explained above, the exponential growth of commercial RF devices demanding more bands lead to the request from wireless communications industry for sharing some of the exiting terrestrial and satellite bands previously assigned to other military and commercial applications based on new priority schemes. Implementation of priority schemes demanded technologies for near real-time interference measurement and modeling in these bands. The objective of interference analysis in commercial world is to optimize utilization of spectrum for intelligent interference management to increase the capacity of wireless communication networks. Science and technology for the analysis of RF cloud interference for intelligent spectrum management is at its infancy and it demands a theoretical foundation to begin a meaningful growth. Here we begin with an analytical study beneficial for analysis and simulation of the interference in an IoT environment, then we propose a method for implementation of an empirical intelligent interference forecasting system (IIFS) with a centralized database for near-real-time interference monitoring and forecasting for the future of all wireless devices.

We can analyze the short term variations of the interference in an IoT environment where many stationary and moving wireless devices interfere with each other based on circular scattering principles. This modeling enables us to have a realistic performance evaluation of the RF cloud interference with any wireless device. FIG. 5 illustrates an interference scenario for N-interferes 512-1 . . . 512-4 (512 generally), uniformly distributed around a target receiver (TG) 510, each with a distance di and a physical angle ai with direction of movement of the device. Referring to FIG. 5, the RF propagation analysis for this scenario resemble the RF multipath propagation with circular scattering for wireless communications applications. In circular scattering for wireless communications the transmitted signal arrives at the receiver from multiple random paths reflected from surrounding objects circling the receiver.

In the interference modeling scenario shown in FIG. 5, multiple interfering signals arrive randomly from multiple IoT devices (interferers) 512 surrounding the target receiver (TG). Defining the amplitudes and phase of the received carrier signal from each of the N-interferes Aᵢ and ϕᵢ respectively, the amplitude, phase, and power, A_{I}, ϕ_{I}, P_{I} of the interference signal at the target device are:

$$\{ \begin{matrix}{A}_{I} {e}^{j {ϕ}_{l}} = {\sum }_{i = 1}^{N} {A}_{i} {e}^{j {ϕ}_{i}} \\ {P}_{I} = {\vert {A}_{I} \vert}^{2}\end{matrix}$$

According to the central limit theorem the distribution function of the in-phase and quadrature phase components of the interference are Gaussian, therefore the distribution functions of amplitude, phase, and power of the interference follow the Rayleigh, uniform, and exponential distributions, respectively:

$$\{ \begin{matrix}{f}_{ϕ} ( φ ) = \frac{1}{2 π} ; - π < φ \leq π \\ {f}_{A} ( a ) = \frac{a}{Γ} {e}^{- {a}^{2} / 2 Γ} \\ {f}_{P} ( p ) = \frac{1}{\overline{{P}_{I}}} {e}^{- p / \overline{{P}_{I}}}\end{matrix} . \qquad ( 5 a )$$

In this equation F is the mean-square amplitude of the arriving signal, and PI is the average received interference power. Knowing the distribution function of power of the interference, we can calculate the average capacity of a communication device with omni directional (OD) and MIMO antennas by integrating Eq. (2a, b) over the distribution of power given in Eq. (5a):

$$\{ \begin{matrix}{\overline{C}}_{OD} \leq \frac{W}{\overline{{P}_{I}}} {\int }_{0}^{∞} {log}_{2} ( 1 + \frac{{P}_{d}}{{N}_{0} W + p} ) {e}^{- p / \overline{{P}_{l}}} dp \\ {\overline{C}}_{MIMO} \leq \frac{W}{\overline{{P}_{I}}} {\int }_{0}^{∞} {\sum }_{i = 1}^{M} {log}_{2} ( 1 + \frac{{P}_{d}}{N ( {N}_{0} W + p )} {λ}_{i} ) {e}^{- p / \overline{{P}_{l}}} dp\end{matrix} . \qquad ( 5 b )$$

Similarly, precision of a positioning system with omnidirectional antennas and MIMO antennas is obtained by integrating Eq. (3a, b) over the distribution of the interference power:

$$\{ \begin{matrix}{CRLB}_{OD} = \overline{{σ}_{r}^{2}} \geq \frac{{c}^{2}}{8 {π}^{2} \times W \times {T}_{M} ( {f}_{0}^{2} + {W}^{2} / 12 ) \times \overline{{P}_{I}}} {\int }_{0}^{∞} \frac{{N}_{0} W + p}{{P}_{d}} {e}^{- p / \overline{{P}_{l}}} dp \\ {CRLB}_{MIMO} = \overline{{σ}_{r}^{2}} \geq \frac{48 \times \overline{{σ}_{r - OD}^{2}}}{N ( {N}^{2} - 1 ) {cos}^{2} α}\end{matrix} \qquad ( 5 c )$$

As a device moves along a path with velocity vₘ the Doppler shift from each interfering source depends on the spatial angle of the direction of movement with the direction of the source, a

$${f}_{d} = \frac{{v}_{m}}{λ} cos α = {f}_{m} cos α α = {cos}^{- 1} ( \frac{{f}_{d}}{{f}_{m}} )$$

For uniform distribution of interference angle, α

$${f}_{A} ( α ) = \frac{1}{2 π} ; - π < α \leq π$$

the Doppler spectrum of the interference is:

$$D ( f ) = {f}_{A} ( α ) \times \vert \frac{d α}{df} \vert = {\frac{1}{2 π {f}_{m}} [ 1 - {( f / {f}_{m} )}^{2} ]}^{- 1 / 2} ; \vert f \vert < {f}_{m} . \qquad ( 5 d )$$

Equations 5c and 5d allow one to simulate the interference for a mobile user for performance analysis by running a complex Gaussian noise through a filter reflecting Doppler spectrum characteristics [12]. Then we can design software and hardware interference simulators to examine the effects of IoT interference on a communication link, a GPS device, or a radar.

The disclosure thus far has provided an analytical model for the temporal behavior of the RF cloud interference and methods to simulate their variations for mobile terminals when we know the average interference power in a location PI. Because of random distribution of location and power levels of interfering wireless devices, randomness in shadowing from objects surrounding them, diversity, and spatial selectivity of antennas for different devices, and randomness in motion of the devices, we need a near real-time empirical interference monitoring system to monitor and forecast the PI in different locations. With a near real-time estimate of PI in all locations, we can optimize utilization of spectrum in that location. A near real-time interference prediction system needs a centralized interference monitoring database to interact with wireless devices to help them optimize the spectrum sharing for wireless communications and to minimize their interference with positioning and navigation systems.

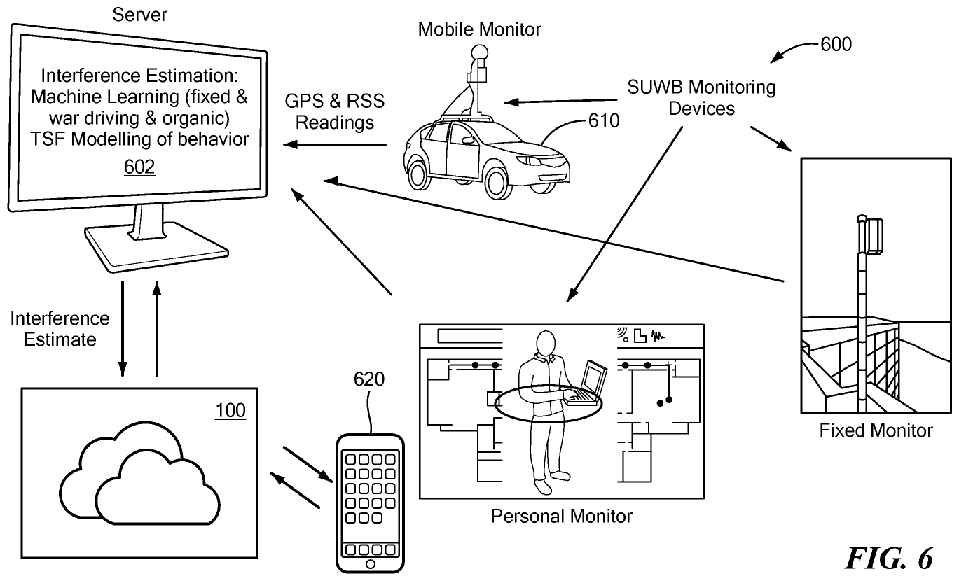

The existing near real-time interference monitoring systems for spectrum management monitor the interference for fixed base stations to enable spectrum sharing with priorities. FIG. 6 shows an architecture 600 for a wireless interference database server 602 environment depicting a physical system for empirical interference monitoring for near real-time intelligent interference forecasting, discussed above as the IIFS. A multi-band programmable scanning software defined radio tuned to all active frequency bands in a region measures the received signal strength from interfering devices, PI. Multiple driving vehicles 610 equipped with multiband scanning devices measure the time-frequency characteristics of the interference in a location, and stamp the measurement with a GPS/WPS/CPS positioning engine estimate of that location. The location stamped measurements are then transferred to the central computing server 602. The target surveying region is traversed in a programmatic route to avoid arterial biases. In an example configuration, the programmatic route includes all drivable streets in the target geographical area following the same driving method for fingerprinting in WPS positioning systems. At the server 602, location, time, and frequencies of the measured PI from different angles of arrival are used to train a machine leaning algorithm such as GAN to create a fingerprint map for the interference in the area and to predict the future interference expectation in time-frequency and location. A user-device 620 with a RF radio platform with cellular, Wi-Fi, Bluetooth, or other emerging egresses, receives the PI of its location from the server to find the optimum egress RF channel for its application, for example to stream a video, establish a telephone conversation, transfer a file, or browse the web. In time the miniature version of multi-band receivers will integrate into the user devices 620 to monitor the interference and make real-time spectrum management at the device 620. These devices report their measurements to the central server 602 to update the database and increase the accuracy of the IIFS database. The database originally created by war driving will update itself with this organic data collected from users as the application grow in time. The need for war driving will reduce in time as the organic data increases by popularity of the database. Prior to expanding the database with war driving with vehicles, the public data on interference measurement programs sponsored by NSF and other government agencies will be fed to the database. The reference database of predicted interference levels of RF devices in each location in a target area is kept in the Edge Cloud to be accessible to all users with minimal delay. AI algorithms update the IIFS database and make predictions of the interference. The interference reports will be available to all users to support their spectrum management objectives. This cyber physical system behavior in growth is expected to follow the pattern of database growth for WPS services. Services providers can benefit from the IIFS database for interference management and ingrate it into the design of their cloud and edge computing facilities to optimize the delay in communications with the devices carrying multi-band chipsets and deliver the report to devices without multi-band receivers.

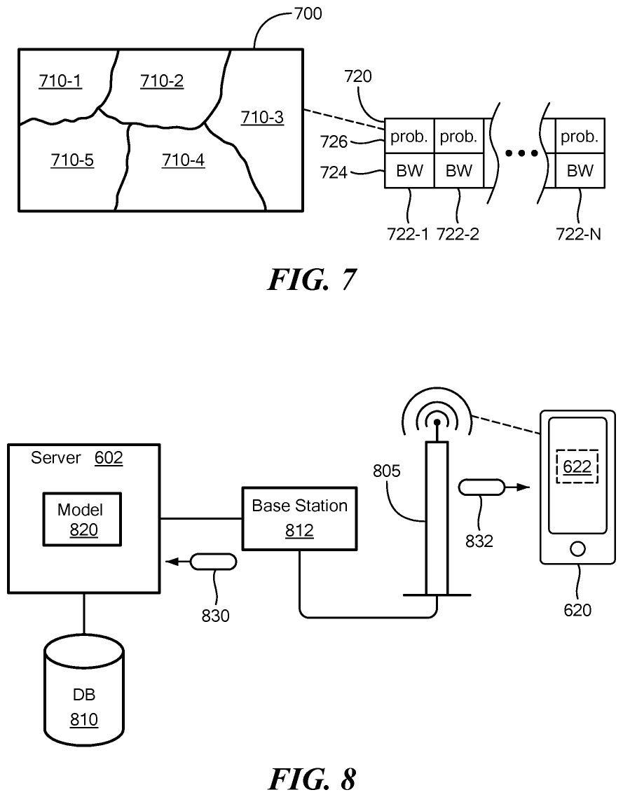

FIG. 7 shows a diagram of an interference map and corresponding interference metrics stored in the database. Referring to FIGS. 1, 6 and 7, the server 602 retrieves the interference information from a fleet of mobile monitors such as vehicles 610, and the mobile monitors gather the interference information over a predetermined coverage region 710-1 . . . 710-5 (710 generally). The coverage region 710 may be any geographical area for which a corpus of interference information sufficient to guide transmission requests around (onto non-interfered frequencies) for effective transmission. For example, the geographic region 700 may have a radius around the server between 1-100 miles, encompassing a metropolitan area around a city or population center.

Upon receiving the gathered interference information, the server 106 coalesces the location indication based on GPS (Global Positioning System) information and WiFi positioning information at a location of the gathering, and maps the location information to interference detected at each of a plurality of bandwidth ranges at the respective location. For each coverage region 710, the interference information 720 may take the form of a series of entries 722-1 . . . 722-N, such that each entry has a respective bandwidth range 724 and a probability 726 of incurring interference at that bandwidth range. Coalescing logic stores the interference information in the database for analytics, learning and interference predictions as discussed below. Other suitable storage arrangements and/or data storage arrangements may be utilized. The interference information may be used to generate an interference map to denote, for each of a plurality of subregions of a geographic region, the interference information for the respective subregion. The interference information can be invoked to allocate frequencies in a location that are free of interference, or less likely to incur interference. In particular configurations, this may include rendering the interference map in a tangible medium of expression, such as a graphical indication of the interference in geographic proximity for illustrative purposes.

Ongoing server 602 operation continues retrieving information from mobile locations, and continual or periodic updating of the stored indications based on receiving revised interference information, such that the revised information may pertaining to the same or different locations for updating the interference map.

FIG. 8 shows a system for invoking the database in the environment of FIG. 6 for supporting telecommunications using a personal mobile device. After populating an initial corpus of interference information, gathering and updating may expand to include any suitable mobile device, in addition to or as a replacement to the traversing vehicles 610. In other words, individual personal communication devices 620 (e.g. smartphones, tablets, laptops) may deploy an application that both gathers interference information for collection by the server 602, and invokes the server to satisfy bandwidth requests for allocating interference free frequencies or subranges in the location of the device 620.

Referring to FIG. 8, the server 602 is in communication with a database 810 and a model 820. The database 810 stores the interference information 720 after gathering the interference information from a variety of sources. This may include receiving the interference information from personal wireless devices 620, in addition to the vehicles 610 deployed specifically for gathering. The personal wireless devices 620 experience a range of mobility. They may be stationary for a time, carried by a walking user, or disposed in a moving vehicle or public transit. Accordingly, a deployment of multiple devices 620, each with an app 622 for gathering interference information, can provide continual updating of location specific interference information. The personal wireless devices therefor have nomadic and vehicular mobility for transmitting interference information from a plurality of locations.

In an operational context, therefore, the environment 600 deploys an app 622 in a plurality of personal wireless devices 620, and records, by each app of the personal wireless devices, the interference information 720 in any suitable form. The server 602 then downloads or received a transmission of the recorded interference information from each of the personal wireless devices 620. Concurrently, as devices need a bandwidth allocation, a bandwidth allocation request 830 is sent to the server 602 from the respective device (note it need not be a cellphone or similar personal device; any suitable bandwidth consumer may request an interference free allocation).

Upon building the database 810 from the interference information 720, the model 820 may be trained using features indicative of the interference level of a bandwidth at the location for the time the interference was detected. The model 820 may employ a neural network, decision tree, or similar regression or related learning technique. Model training continues to generate the interference data or map for bandwidth ranges or subranges, location, and a probability of encountering (or not encountering) interference. Analytics logic invokes the model 820 for satisfying requests for bandwidth allocation. The model could also encompass a time of day recognition for variance at different times. Based on the location of the request, and a suitable frequency for the type of usage or traffic to be transmitted, the server 602 satisfying the request by computing a probability of interference at the location for a particular bandwidth, and returns the allocation response 832 for the suitable bandwidth having the lowest probability of encountering interference.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as solid state drives (SSDs) and media, flash drives, floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions, including virtual machines and hypervisor controlled execution environments. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

1. A method for identifying interference in a shared spectrum environment of wireless devices, comprising:
gathering interference information including bandwidth ranges and locations from a plurality of deployed devices;
storing an indication of a plurality of location and interference at each location of the plurality of locations based on the interference information;
receiving a request for a bandwidth allocation, the request emanating from a remote location; and
satisfying the request by allocating a non-interfering bandwidth at the remote location based on the stored indications.

2. The method of claim 1 further comprising receiving the interference information from personal wireless devices, the personal wireless devices having nomadic and vehicular mobility for transmitting interference information from a plurality of locations.

3. The method of claim 1 further comprising:
deploying an app in a plurality of personal wireless devices;
recording, by each app of the personal wireless devices, the interference information; and
downloading the recorded interference information from each of the personal wireless devices.

4. The method of claim 1 further comprising:
retrieving the interference information from a fleet of mobile monitors, the mobile monitors gathering the interference information over a predetermined coverage region.

5. The method of claim 1 further comprising:
coalescing the location indication based on GPS (Global Positioning System) information and WiFi positioning information at a location of the gathering, and
mapping the location information to interference detected at each of a plurality of bandwidth ranges at the respective location.

6. The method of claim 1 further comprising:
training a model using features indicative of the interference level of a bandwidth at the location for the time the interference was detected, and
satisfying the request by computing a probability of interference at the location for a future time.

7. The method of claim 1 further comprising:
generating an interference map, the interference map having, for each of a plurality of subregions of a geographic region, the interference information for the respective subregion; and
rendering the interference map in a tangible medium of expression.

8. The method of claim 1 wherein gathering retrieves information from mobile locations, further comprising:
updating the stored indications based on receiving revised interference information, the revised information pertaining to a different location.

9. The method of claim 7 wherein the geographic region has a radius around the server between 1-100 miles.

10. A system for identifying interference and allocating bandwidth in a shared spectrum environment of wireless devices, comprising:
a server for gathering interference information including bandwidth ranges and locations from a plurality of deployed devices;
a database in communication with the server for storing an indication of a plurality of location and interference at each location of the plurality of locations based on the interference information;
a network interface configured to receive a request for a bandwidth allocation, the request emanating from a remote location; and
analytics logic for satisfying the request by allocating a non-interfering bandwidth at the remote location based on the stored indications.

11. The system of claim 10 further comprising a network interface to a plurality of personal wireless devices for receiving the interference information, the personal wireless devices having nomadic and vehicular mobility for transmitting interference information from a plurality of locations.

12. The system of claim 10 further comprising:
an app deployed in the plurality of personal wireless devices, the app configured for: recording the interference information; and
transmitting the recorded interference information to the server.

13. The system of claim 10 further comprising:
a fleet of mobile monitors for gathering the interference information over a predetermined coverage region.

14. The system of claim 10, wherein the coalescing logic is configured for:
coalescing the location indication based on GPS (Global Positioning System) information and WiFi positioning information at a location of the gathering, and
mapping the location information to interference detected at each of a plurality of bandwidth ranges at the respective location.

15. The system of claim 10 further comprising:
a model trained from features indicative of the interference level of a bandwidth at the location for the time the interference was detected; and
an inference engine, the model responsive to the inference engine for satisfying the request by computing a probability of interference at the location for a future time.

16. The system of claim 10 further comprising:
an interference map, the interference map having, for each of a plurality of subregions of a geographic region, the interference information for the respective subregion

17. The system of claim 1 further comprising a plurality of mobile locations, the server responsive to each of the plurality of mobile locations for updating the stored indications based on receiving revised interference information, the revised information pertaining to a different location.

18. A computer program embodying program code on a non-transitory computer readable storage medium that, when executed by a processor, performs steps for implementing a method for method for identifying interference in a shared spectrum environment of wireless devices, the method comprising:
gathering interference information including bandwidth ranges and locations from a plurality of deployed devices;
storing an indication of a plurality of location and interference at each location of the plurality of locations based on the interference information;
receiving a request for a bandwidth allocation, the request emanating from a remote location; and
satisfying the request by allocating a non-interfering bandwidth at the remote location based on the stored indications.
